(19) United States
(12) Patent Application Publication
(10) Pub. No.: US 2007/0262547 A1
(43) Pub. Date: Nov. 15, 2007

(54) LEAF SPRING WITH HIGH AUXILIARY ROLL STIFFNESS

(75) Inventor: Derek K. Warinner, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 11/382,393

(22) Filed: May 9, 2006

(51) Int. Cl. B60G 7/00; B60G 11/02

(52) U.S. Cl. 280/124.17; 280/124.174; 267/36.1; 267/47

(57) ABSTRACT

A vehicle suspension provides increased auxiliary roll stiffness by utilizing spring assemblies having a thick truncated half-leaf, a thin full-leaf, and a thin truncated half-leaf located opposite the thick truncated half-leaf. The thick truncated half-leaf increases the torsional rigidity of the spring assembly in order to increase the leaf twist sub-component of auxiliary roll stiffness and increases the bending rigidity of half of the spring assembly in order to increase the axle torsion sub-component of auxiliary roll stiffness. The thin full-leaf provides structural integrity, and the thin half-leaf allows tuning of the overall vertical spring rate of the suspension and limits the leaf stresses in the thin full-leaf.

### BACKGROUND OF THE INVENTION

This invention relates to the use of leaf springs as suspension elements for ground-traveling vehicles and the role that they play in resisting vehicle body roll. Specifically, a set of leaf springs is set forth utilizing thick and thin truncated half-leafs, such that auxiliary roll stiffness, or that component of roll stiffness not related to lateral spacing, is increased.

### SUMMARY OF THE INVENTION

Ground-traveling vehicles are generally provided with suspension elements to absorb shocks to the vehicle resulting from unevenness of the ground and the forward velocity of the vehicle. As is well-known in the art, these suspension elements include some type of spring, some type of damping element, and either a full or partial axle. The simplest type of vehicle suspension, and still commonly used in heavy-duty vehicles, is the double leaf spring and solid axle arrangement. This type of vehicle suspension has many positive attributes. It is robust and simple to manufacture. It is vertically compliant and laterally rigid, yet capable of carrying heavy vehicle loads. However, unmodified it is also yields unacceptably to vehicle body roll.

A major limiting factor in a double leaf spring and solid axle suspension's ability to resist vehicle body roll is the lateral spacing between the spring centers. This, in turn is limited by overall vehicle width and the amount of space required both by wheel and tire articulation, and by the vehicle brakes. The relationship between a double leaf spring and solid axle suspension's vertical spring rate, its lateral spacing between spring centers, and its roll stiffness has heretofore been somewhat fixed. Specifically, the roll stiffness for a suspension of this configuration equals the leaf spring vertical spring rate multiplied by the square of the spring center distance, plus an auxiliary roll stiffness generated primarily by leaf twist and torsion of the axle. The most generally employed solution to overcoming this fixed relationship has been the use of a stabilizer bar, which is a member that is attached to the vehicle frame in two places and linked to the axle at its ends. Alternately, the stabilizer bar may be attached to the axle in two places and linked to the vehicle frame at its ends. During vertical motion of the axle, the stabilizer bar articulates freely, but during vehicle body roll, the stabilizer bar undergoes torsion along its length, thus resisting the vehicle body roll.

The invention as set forth herein discloses techniques for increasing the auxiliary roll stiffness component of roll stiffness, thus reducing or eliminating the need for a stabilizer bar. The ability of a traditional multi-leaf or taper-leaf spring to deliver auxiliary roll stiffness previous to this invention has been limited. For a twelve-thousand pound capacity suspension having fifty-eight inch long springs on approximately fifty-two-inch spring centers, for example, fifteen thousand inch pounds per degree of body roll are contributed by primary roll stiffness due to spring rate and spacing. Only ten thousand inch pounds per degree of body roll are contributed by auxiliary roll stiffness.

Some attempts to increase this auxiliary roll stiffness component have been made previous to the invention set forth herein. Vehicle manufacturers have achieved limited success by increasing the longitudinal asymmetry of the spacing of the axle upon the springs. Specifically, by locating the axle at a point between of the midpoint of the leaf springs and their direct connection to the vehicle frame via the spring hanger, and by increasing the torsional stiffness of the axle, approximately ten percent gains have been made in the auxiliary roll stiffness component. This is due to a correlating increase in both of the two subcomponents of the auxiliary roll stiffness component, leaf twist and axle torsion.

The increase in the leaf twist subcomponent can be visualized as follows. As the vehicle negotiates a change in direction, the springs are loaded asymmetrically in the lateral direction. As a result the vehicle body leans. This produces an angularity between the axle and the vehicle frame in the lateral direction, with the outer spring compressed to a greater extent, and the inner spring relieved to some extent. The springs become the compliant member which accepts this angular difference. That is, they are twisted slightly along their length. Because the leaf springs are affixed to the chassis at their extremities, the twist occurs between the front spring eye and the mid-point axle attachment, and between the rear spring eye and the mid-point axle attachment. The ability of each spring half-portion of the overall length to resist this twist is a function of the shear modulus of the material, its polar moment of inertia, and the length of that half-portion. Because the torsional spring rate of the spring half-portion of the overall length is a function of the inverse of the length of that half-portion, the rate at which the torsional spring rate increases for the spring half-portion which is made shorter by longitudinal asymmetry becomes rapidly greater than the rate at which the torsional spring rate decreases for the spring half-portion which is made longer by that same longitudinal asymmetry. Because the direct connection between the spring and the vehicle frame via the spring hanger is generally more rigid than the connection via the spring shackle, or the member which compensates for the variation of the spring length upon deflection, that is generally the end of the spring toward which the axle is located.

The increase in the axle torsion subcomponent of auxiliary roll stiffness can be visualized as follows. As the vehicle leans, the outer spring is compressed to a greater extent, and the inner spring is relieved to some extent, as mentioned previously. As a leaf spring is compressed, it generally flattens in the case of a parabolic spring, or becomes invertedly parabolic in the case of a flat spring. It also changes in distance between the spring eyes, which explains the need for the spring shackle mentioned previously. At some point at or near its mid-point, a tangent drawn to the spring at that point remains at a fairly constant angle relative to the longitudinal axis of the vehicle throughout deflection of the spring. Forward and rearward of that theoretical midpoint, the angle between a tangent drawn to the spring and the longitudinal axis of the vehicle will change throughout deflection of the spring. By attaching the axle to a point other than that theoretical midpoint, generally in the direction from the theoretical midpoint toward the direct connection between the spring and the vehicle frame via the spring hanger, torsion is introduced to the axle, due to the fact that the inner and outer springs are deflecting in opposite directions resulting in opposite changes in the angularity between the tangents drawn to the springs and the longitudinal axis of the vehicle. By also increasing the torsional rigidity of the axle, the axle torsion subcomponent of auxiliary roll stiffness is increased.

Remembering that these subcomponents together have previously contributed to an approximate increase in auxiliary roll stiffness of only ten percent when longitudinal asymmetry has been increased previous to the invention disclosed herein, attempts have been made to further increase the contribution of both subcomponents of the auxiliary roll stiffness component, leaf twist and axle torsion, by thickening a half-portion of the leaf spring overall length. Typically, the half-portion of the overall length of the leaf spring toward the direct connection between it and the vehicle frame via the spring hanger has been made thicker, so that the half-portion of the leaf spring toward the spring shackle was required to accommodate a greater degree of deflection. This increased the polar moment of inertia of the thicker half-portion of the leaf spring, thereby increasing the leaf twist subcomponent of the auxiliary roll stiffness component. Thickening the half-portion of the leaf spring also forced the angle between the tangent drawn to the spring at the point where the axle is attached and the longitudinal axis of the vehicle to change to a greater degree during deflection. The resulting increase in torsion of the axle increased the axle torsion subcomponent of the auxiliary roll stiffness component of overall roll stiffness.

The approach of thickening a half-portion of the leaf spring overall length in order to increase auxiliary roll stiffness is limited, however, by a corresponding increase in leaf spring stress in the thinner half-portion of the spring. This increase in leaf spring stress has forced vehicle suspension manufacturers to include additional spring elements, typically air or rubber springs located between the axle and the vehicle frame, in order to reduce the leaf spring stress to an acceptable level. These additional spring elements are often added at a significant cost penalty, in order to achieve the level of roll stiffness desired.

The invention disclosed herein allows for an increased level of roll stiffness by increasing the auxiliary roll stiffness component via the use of a thick truncated half-leaf, while alleviating a corresponding increase in leaf stress via the use of an opposing thinner truncated half-leaf. This is accomplished by constructing a leaf spring assembly comprised of a first upper thick truncated half-leaf nearest the direct connection between the spring assembly and the vehicle frame via the spring hanger, a second full length thinner leaf, and a third lower truncated half-leaf of sufficient thickness to generate the desired vertical stiffness, located opposite the first upper thick truncated half-leaf. The upper thick truncated half-leaf gives the increased polar moment of inertia required for increasing the leaf twist subcomponent of the auxiliary roll stiffness component, and forces the angle between the tangent drawn to the spring at the point where the axle is attached and the longitudinal axis of the vehicle to change to a greater degree during deflection, thereby increasing the axle torsion subcomponent of the auxiliary roll stiffness component when used with a torsionally rigid axle. The second full length leaf provides vertical stiffness and structural redundancy via the front eye wrap at the direct connection to the vehicle frame via the spring hanger and the rear eye wrap at the spring shackle connection. The third lower truncated half-leaf allows for tuning of the vertical stiffness while minimizing leaf stresses in itself and the second full length leaf.

An alternate embodiment is comprised of a leaf spring assembly having a lower thick truncated half-leaf nearest the direct connection between the spring assembly and the vehicle frame via the spring hanger, a second full length thinner leaf, and a third upper truncated half-leaf of sufficient thickness to generate the desired vertical stiffness, located opposite the first lower thick truncated half-leaf. The lower thick truncated half leaf in this embodiment functions in exactly the same way as the upper thick truncated half leaf in the previous embodiment.

There are many advantages to utilizing a suspension having spring assemblies of this type. The suspension may be tuned more aggressively, having a relatively low vertical spring rate overall, while maintaining high roll stiffness. It exhibits typical jounce and rebound travel, due to control of spring stress to within normal limits. Furthermore, it is economical to implement, as the spring assembly is compatible with conventional spring mounting and axle attachments. There is a reduced need for a stabilizer bar, allowing for the possible elimination of the stabilizer bar and attachments altogether.

The leafs and half-leafs of the present invention may be of either parabolic taper shape or flat shape. The thick and thin half-leafs may be approximately the same length, or they may be asymmetric in either direction. The suspension utilizing the spring assemblies of the present invention may be located at the front or rear positions upon the vehicle, and may be used with driving or non-driving axles. The spring assemblies may be oriented thick half-leaf forward in a suspension having the spring hanger forward and spring shackle rearward, or may be oriented thick half-leaf rearward in a suspension having the spring hanger rearward and spring shackle forward, depending on the suspension characteristics required.

### BRIEF DESCRIPTION OF THE DRAWINGS

FIG. 1—A ground vehicle traveling over uneven terrain.

FIG. 2—A prior-art conventional leaf spring suspension.

FIG. 3—A ground vehicle undergoing body roll.

FIG. 4—A prior-art conventional leaf spring suspension having a stabilizer bar.

FIG. 5—A prior-art asymmetric leaf spring suspension.

FIG. 6—A view showing leaf twist operating to resist body roll.

FIG. 7—A view showing axle torsion operating to resist body roll.

FIG. 8—A prior-art leaf spring suspension having thicker half-portions of the overall spring length, with an additional spring element.

FIG. 9—A view of a first embodiment of the invention.

FIG. 10—A view of a second embodiment of the invention.

FIG. 11—A view of a third embodiment of the invention.

FIG. 12—A view of a fourth embodiment of the invention.

FIG. 13—A view of a fifth embodiment of the invention.

FIG. 14—A view of a sixth embodiment of the invention.

### DESCRIPTION OF THE INVENTION

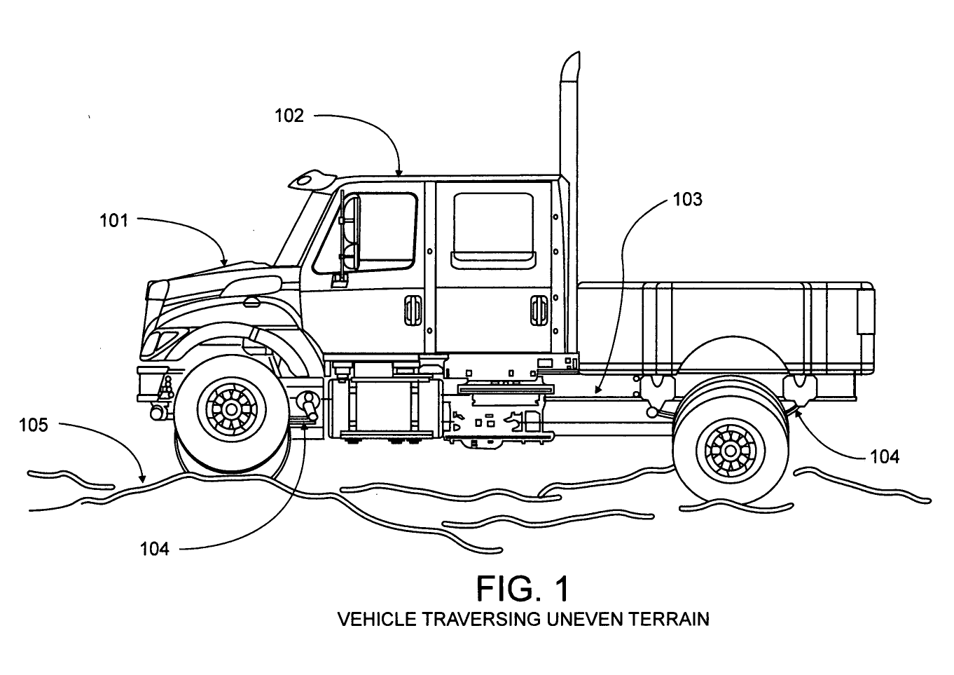

The vehicle 101 shown in FIG. 1 has a body 102 attached to a frame 103. The vehicle 101 is shown traversing uneven terrain 105, which causes the conventional leaf spring suspension 104 attached to the frame 103 to deflect.

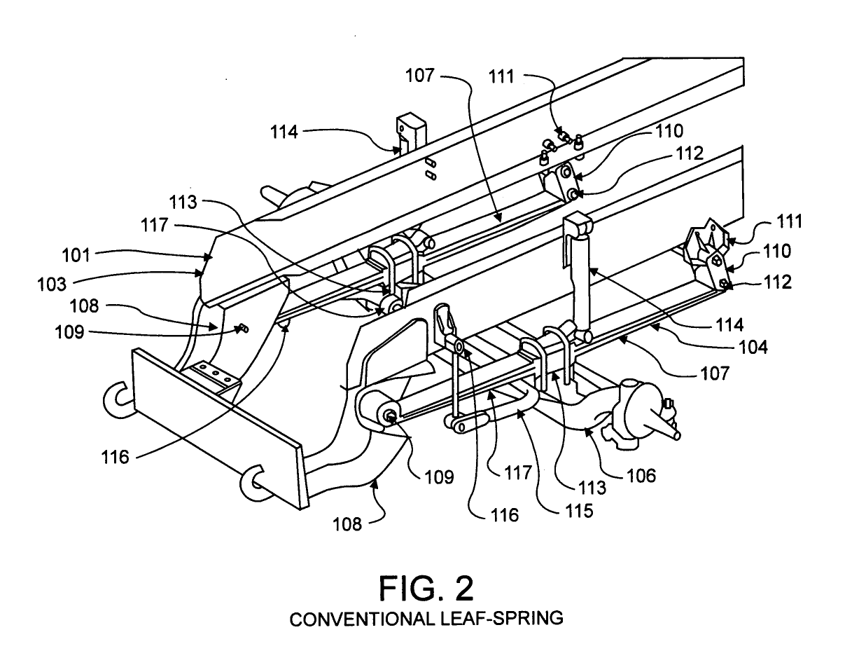

FIG. 2 shows a prior-art conventional leaf spring suspension 104 attached to the frame 103 of the vehicle 101. The body 102 of vehicle 101 is not shown. The frame 103 is provided with spring hangers 108 and spring shackle attachments 111, to which are attached leaf springs 107 and spring shackles 110. The leaf springs 107 are attached to the spring hangers 108 at the spring hanger connections 109, and to the spring shackles 110 at the spring shackle connections 112. Note that one of the spring hangers 108 is shown partially cut-away, in order to better illustrate the attachment of the leaf spring 107 to the spring hanger connection 109. A solid front steerable axle 106 is attached to the leaf springs 107 by the axle attachments 113. The conventional leaf spring suspension 104 is further provided with damper elements 114 and a stabilizer bar 115, which stabilizer bar 115 is attached to the solid front steerable axle 106 at two stabilizer bar axle connections 117, and linked to the frame 103 by the stabilizer bar frame links 116. The damper elements 114 are connected to the frame 103 and to the leaf springs 107 at or near the axle attachments 113.

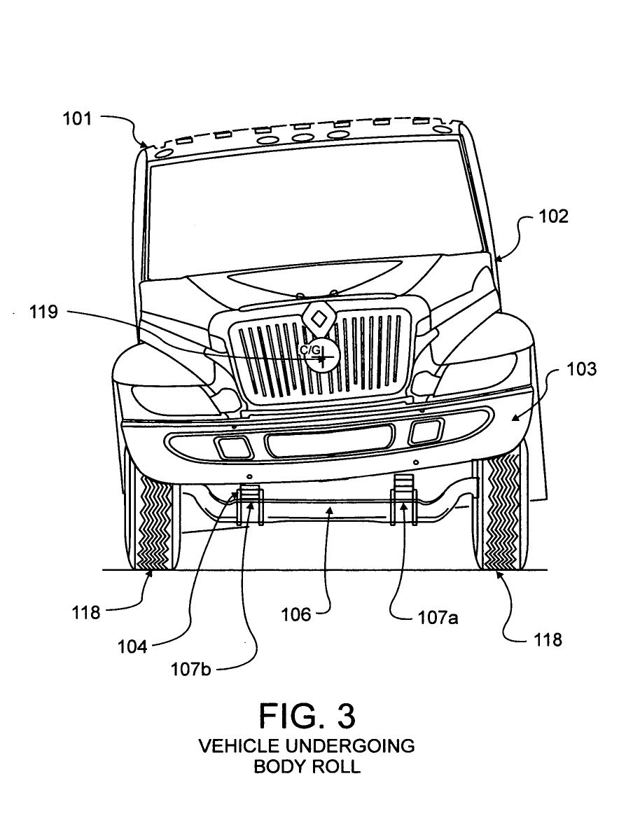

FIG. 3 shows a vehicle 101 undergoing body roll. Centripetal force acting upon the tire to ground contact patches 118 results in a moment about the vehicle center of gravity 119, which moment is counteracted by the conventional leaf spring suspension 104. As a result, the frame 103 and body 102 lean outward, partially compressing outer leaf spring 107b, and partially relieving inner leaf spring 107a. The solid front steerable axle 106 remains relatively level with the ground.

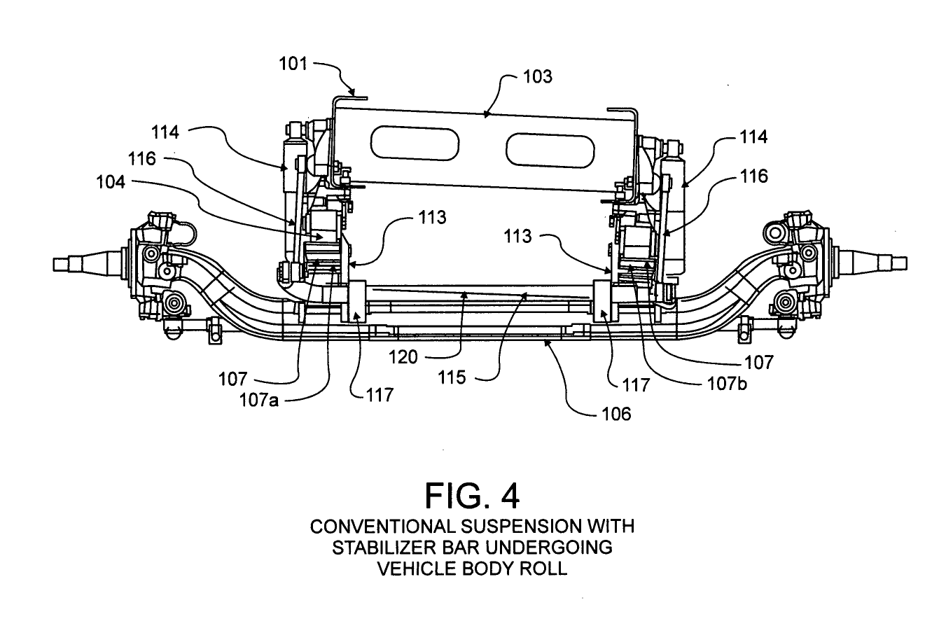

FIG. 4 shows a vehicle 101 having a prior-art conventional leaf spring suspension 104 having a stabilizer bar 115 and undergoing deflection as a result of vehicle body roll. The conventional leaf spring suspension 104 is comprised of the solid front steerable axle 106, the leaf springs 107, the damper elements 114, and the stabilizer bar 115. The body 102 of vehicle 101 is not shown. The frame 103 is at an angle relative to the solid front steerable axle 106, causing the outer leaf spring 107b to be partially compressed and the inner leaf spring 107a to be partially relieved. The stabilizer bar 115 is connected to the solid front steerable axle 106 at two stabilizer bar axle connections 117, and is linked to the frame 103 by two stabilizer frame links 116. The damper elements 114 are connected to the frame 103 and to the leaf springs 107 at or near the axle attachments 113. The angle between the frame 103 and the solid front steerable axle 106 causes the stabilizer bar 115 to twist along its length. This twist is emphasized in FIG. 4 by a reference line 120, which reference line 120 is straight and parallel to the axis of the stabilizer bar 115 when the stabilizer bar 115 is not undergoing twist. The stabilizer bar 115 has a given torsional spring rate, such that it exerts torque in the restorative direction when it is twisted, and thereby resists vehicle body roll.

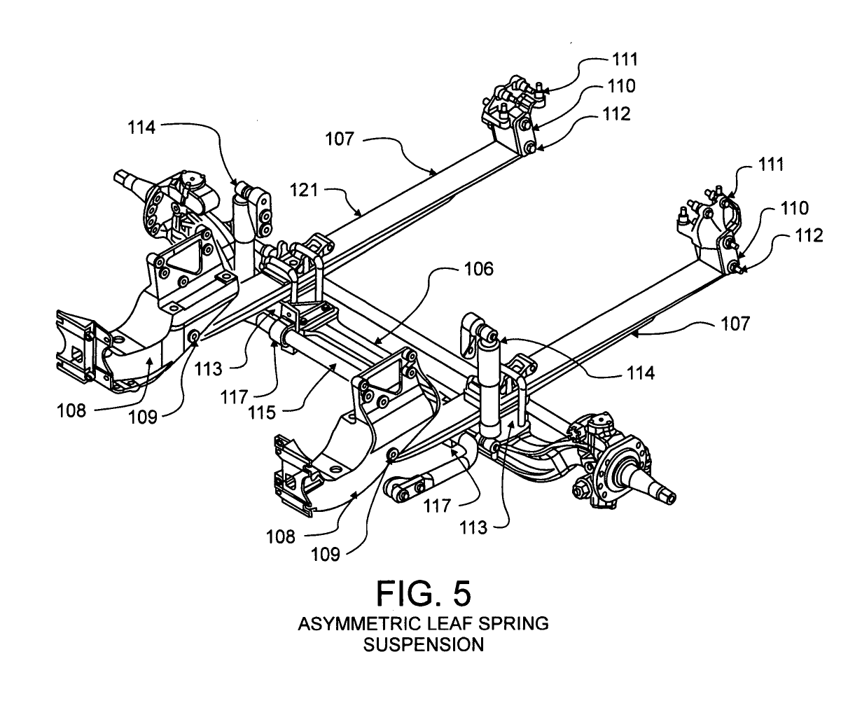

FIG. 5 shows a prior-art asymmetric leaf spring front suspension 121. The asymmetric leaf spring front suspension 121 is comprised of the solid front steerable axle 106, the leaf springs 107, the damper elements 114, and the stabilizer bar 115. Neither the body 102 nor the frame 103 of the vehicle 101, to which the asymmetric leaf spring front suspension 121 would be attached, are shown. The solid front steerable axle 106 is attached to the leaf springs 107 at the axle attachments 113, which are more proximate to the spring hangers 108 and spring hanger connections 109 than to the spring shackles 110, spring shackle attachments 111, and spring shackle connections 112. As in the conventional leaf spring suspension 104 of FIG. 2, the stabilizer bar 115 is attached to the solid front steerable axle 106 at two stabilizer bar axle connections 117, and linked to the frame 103, which is not shown in FIG. 5, by the stabilizer bar frame links 116, which are also not shown in FIG. 5. Similar to the conventional leaf spring suspension 104 of FIG. 2, the damper elements 114 are connected to the frame 103, which is not shown in FIG. 5, and in this particular embodiment to the solid front steerable axle 106 at or near the axle attachments 113.

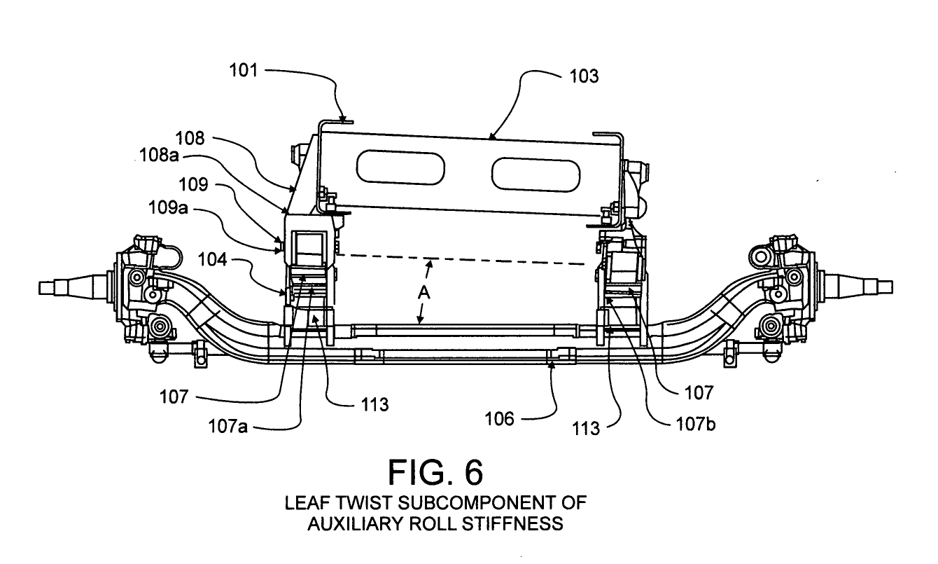

FIG. 6 shows a vehicle 101 having a conventional leaf spring suspension 104 and undergoing deflection as a result of vehicle body roll. The conventional leaf spring suspension 104 is comprised of the solid front steerable axle 106 and the leaf springs 107. The solid front steerable axle 106 is attached to the leaf springs 107 at the axle attachments 113. The leaf springs 107, in turn, are connected to the spring hangers 108 at the spring hanger connections 109, of which only the right side spring hanger 108a and the right side spring hanger connection 109a are shown attached to the right leaf spring 107a. The left side spring hanger 108b and the left side spring hanger connection 109b are removed to better show the left leaf spring 107b. The spring hangers 108 are in turn attached to the frame 103. For simplicity, the body 102 of vehicle 101 is not shown, nor are the stabilizer bar 115, the two stabilizer frame links 116, nor the damper elements 114 of the conventional leaf spring suspension 104. The frame 103 is at an angle “A” relative to the solid front steerable axle 106, causing the outer leaf spring 107b to be partially compressed and the inner leaf spring 107a to be partially relieved. The angle “A” between the frame 103 and the solid front steerable axle 106 causes the leaf springs 107 to twist along their length between the spring hanger connections 109 and the axle attachment 113. The resistance of the leaf springs 107 to being twisted in this way contributes the leaf twist subcomponent of the auxiliary roll stiffness component mentioned previously. Similarly, the angle “A” between the frame 103 and the solid front steerable axle 106 causes the leaf springs 107 to twist along their length between the axle attachment 113 and the spring shackles 110 (not shown). This also contributes to the leaf twist subcomponent of the auxiliary roll stiffness.

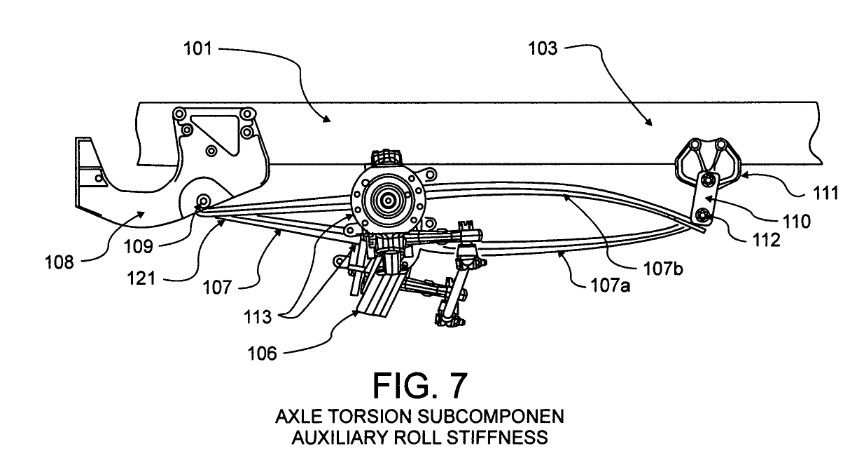

FIG. 7 shows a vehicle 101 having an asymmetric leaf spring front suspension 121 and undergoing deflection as a result of vehicle body roll. The asymmetric leaf spring front suspension 121 is comprised of the solid front steerable axle 106 and the leaf springs 107. The solid front steerable axle 106 is attached to the leaf springs 107 at the axle attachments 113. The leaf springs 107, in turn, are connected to the spring hangers 108 at the spring hanger connections 109, which spring hangers 108 are attached to the frame 103. The leaf springs 107 are also connected to the spring shackles 110 at the spring shackle connections 112, which spring shackles 110 are in turn connected to the spring shackle attachments 111. The spring shackle attachments 111 are attached to the frame 103. Note that the axle attachments 113 are located upon the leaf springs 107 nearer the spring hangers 108 than to the spring shackles 110. For simplicity, the vehicle body 102, the damper elements 114, and the stabilizer bar 115 are not shown. In FIG. 7, the frame 103 is shown level, such that the viewpoint of FIG. 7 uses the leaning vehicle 101 as its frame of reference. Therefore, the outer leaf spring 107b is shown partially compressed, and the inner leaf spring 107a is shown partially relieved relative to the level frame 103. The point at which the solid front steerable axle 106 is attached to the outer leaf spring 107b is rotated in a positive direction relative to the frame of reference of FIG. 7 as a result of the compression of the outer leaf spring 107b and the proximity of the axle attachment 113 of the solid front steerable axle 106 along the length of the outer leaf spring 107b to the spring hanger 108. The point at which the solid front steerable axle 106 is attached to the inner leaf spring 107a is rotated in a negative direction relative to the frame of reference of FIG. 7 as a result of the relief of the inner leaf spring 107a and the proximity of the axle attachment 113 of the solid front steerable axle 106 along the length of the inner leaf spring 107a to the spring hanger 108. The opposite rotations of the axle attachments 113 of the solid front steerable axle 106 to the inner leaf spring 107a and to the outer leaf spring 107b causes the solid front steerable axle 106 to twist along its length. The resistance of the solid front steerable axle 106 to being twisted in this way contributes the axle torsion subcomponent of the auxiliary roll stiffness component mentioned previously.

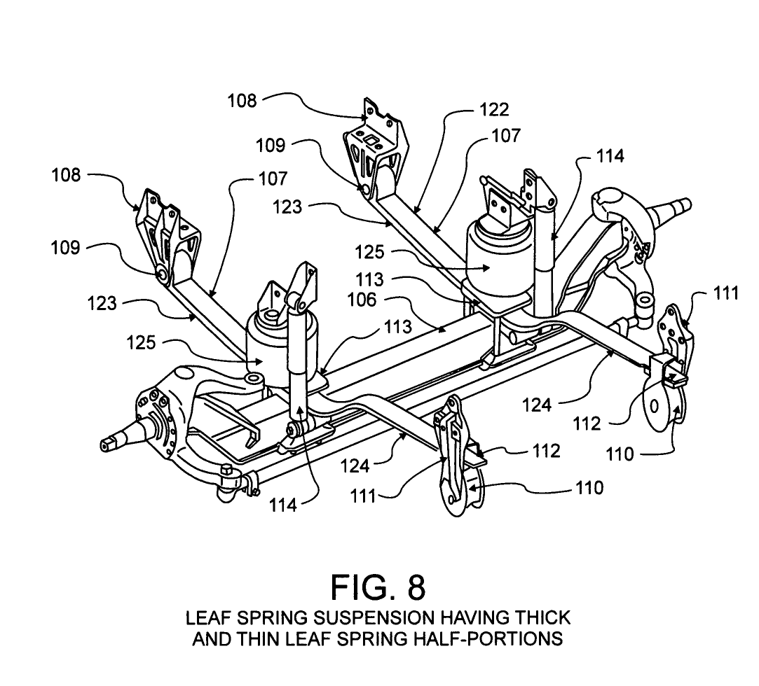

FIG. 8 shows a prior-art leaf spring suspension 122 having thicker half-portions 123 of the overall length of the leaf springs 107 and thinner half-portions 124 of the overall length of the leaf springs 107. Note for clarity, neither the body 102 nor the frame 103 are shown. The leaf spring suspension 122 is generally comprised of the leaf springs 107 and the solid front steerable axle 106. The solid front steerable axle 106 is attached to the leaf springs 107 at the axle attachments 113. The leaf springs 107, in turn, are connected to the spring hangers 108 at the spring hanger connections 109. The damper elements 114 are connected to the frame 103, which is not shown in FIG. 8, and to the solid front steerable axle 106 at or near the axle attachments 113. The leaf springs 107 are also connected to the spring shackles 110 at the spring shackle connections 112, which spring shackles 110 are in turn connected to the spring shackle attachments 111. Note that in this particular design, the spring shackles 110 are inverted and the spring shackle connections 112 are of a sliding nature. This is inconsequential to the performance of the leaf spring suspension 122 having leaf springs 107 with thicker half-portions 123 and thinner half-portions 124. However, the additional elements that are consequential to the performance of the leaf spring suspension 122 having leaf springs 107 with thicker half-portions 123 and thinner half-portions 124, and which must be present in order for the leaf springs 107 of the leaf spring suspension 122 in this configuration to withstand normal stresses, are the additional spring elements 125. The additional spring elements 125 are attached to the leaf springs 107 at or near the axle attachments 113, and are further attached to the frame 103, which is not shown in FIG. 8.

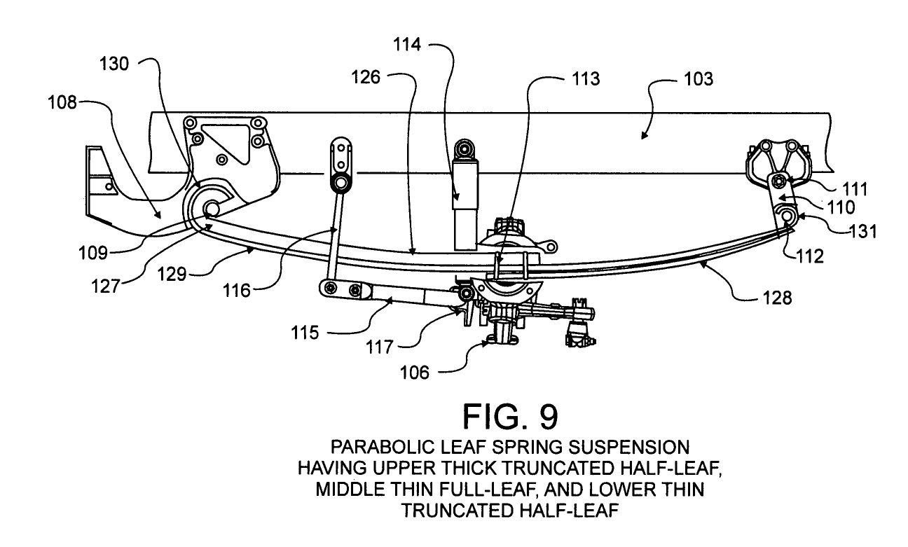

FIG. 9 shows an embodiment of the present invention, a parabolic leaf spring front suspension 126 having upper thick truncated half-leafs 127, thin full leafs 129 with front eye wraps 130 and rear eye wraps 131, and lower thin truncated half-leafs 128. Note for clarity, the body 102 is not shown. The solid front steerable axle 106 is shown partially cut-away, such that the axle attachments 113 to the upper thick truncated half-leafs 127, the thin full leafs 129, and the lower thin truncated half-leafs 128 may be more clearly illustrated. In the same way, one spring hanger 108 is shown partially cut-away, so that the front eye wraps 130 may be more clearly illustrated as attached to the spring hanger connections 109. One spring shackle 110 is shown partially cut-away as well, so that the rear eye wraps 131 may be more clearly illustrated as attached to the spring shackle connections 112. As in the prior art suspensions, the spring hangers 108 are attached to the frame 103, and the spring shackle connections 112 are attached to the spring shackles 110, which spring shackles 110 are connected to the spring shackle attachments 111, which spring shackle attachments 111 are attached to the frame 103. The parabolic leaf spring front suspension 126 with the upper thick truncated half-leafs 127, the thin full leafs 129, and the lower thin truncated half-leafs 128, is provided with damper elements 114, which are also shown partially cut-away, and a stabilizer bar 115. However, the parabolic leaf spring front suspension 126 of the present invention may be provided with or without the stabilizer bar 115. As in the prior art suspensions, the stabilizer bar 115 is attached to the solid front steerable axle 106 by means of the stabilizer bar axle connections 117, and is attached to the frame 103 by means of the stabilizer bar frame links 116. The damper elements 114 are connected to the frame 103 and to the solid front steerable axle 106 at or near the axle attachments 113.

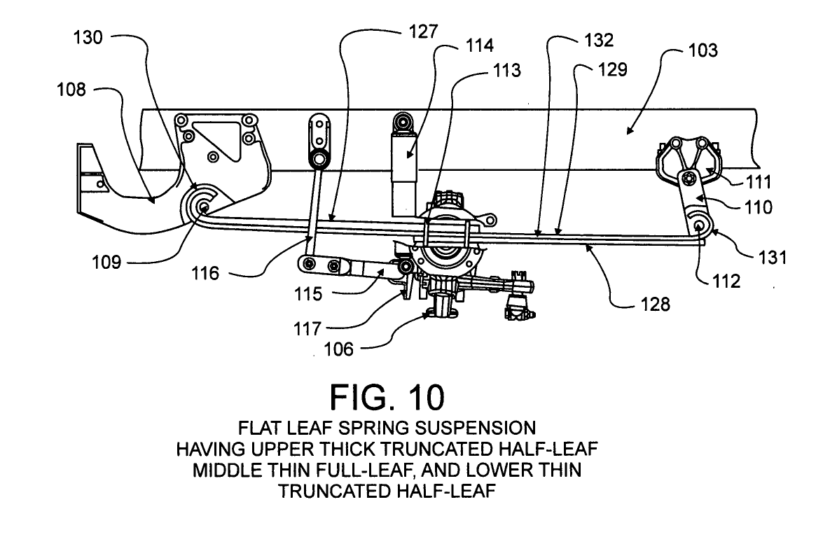

FIG. 10 shows an embodiment of the present invention, a flat leaf spring front suspension 132 having upper thick truncated half-leafs 127, thin full leafs 129 with front eye wraps 130 and rear eye wraps 131, and lower thin truncated half-leafs 128. Note for clarity, the body 102 is not shown. The solid front steerable axle 106 is shown partially cut-away, such that the axle attachments 113 to the upper thick truncated half-leafs 127, the thin full leafs 129, and the lower thin truncated half-leafs 128 may be more clearly illustrated. In the same way, one spring hanger 108 is shown partially cut-away, so that the front eye wraps 130 may be more clearly illustrated as attached to the spring hanger connections 109. One spring shackle 110 is shown partially cut-away as well, so that the rear eye wraps 131 may be more clearly illustrated as attached to the spring shackle connections 112. As in the prior art suspensions, the spring hangers 108 are attached to the frame 103, and the spring shackle connections 112 are attached to the spring shackles 110, which spring shackles 110 are connected to the spring shackle attachments 111, which spring shackle attachments 111 are attached to the frame 103. The flat leaf spring front suspension 132 with the upper thick truncated half-leafs 127, the thin full leafs 129, and the lower thin truncated half-leafs 128, is provided with damper elements 114, which are also shown partially cut-away, and a stabilizer bar 115. However, like the parabolic leaf spring front suspension 126 in FIG. 9, the flat leaf spring front suspension 132 of the present invention shown in FIG. 10 may be provided with or without the stabilizer bar 115. As in the prior art suspensions, the stabilizer bar 115 is attached to the solid front steerable axle 106 by means of the stabilizer bar axle connections 117, and is attached to the frame 103 by means of the stabilizer bar frame links 116. The damper elements 114 are connected to the frame 103 and to the solid front steerable axle 106 at or near the axle attachments 113.

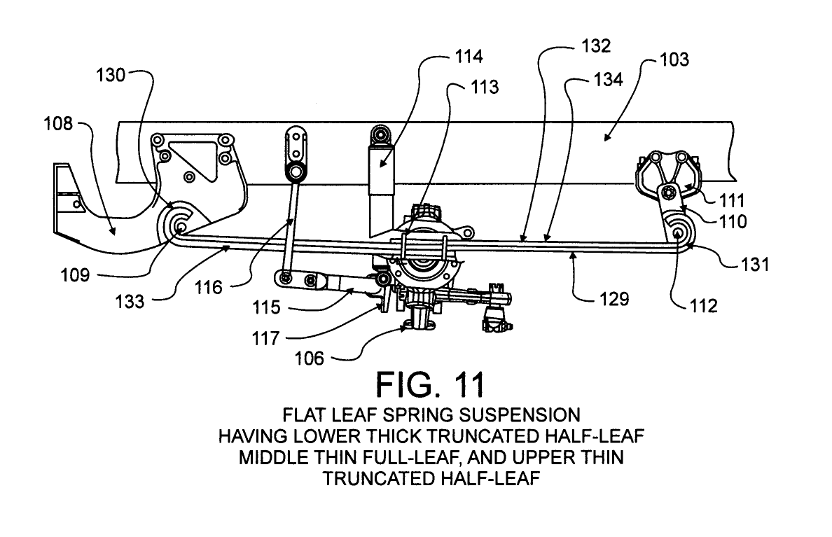

FIG. 11 shows an embodiment of the present invention, a flat leaf spring front suspension 132, similar to the flat leaf spring front suspension 132 in FIG. 10. The flat leaf spring front suspension 132 shown in FIG. 11 is provided with lower thick truncated half-leafs 133, thin full leafs 129 with front eye wraps 130 and rear eye wraps 131, and upper thin truncated half-leafs 134. Note for clarity, the body 102 is again not shown. The solid front steerable axle 106 is shown partially cut-away, such that the axle attachments 113 to the lower thick truncated half-leafs 133, the thin full leafs 129, and the upper thin truncated half-leafs 134 may be more clearly illustrated. In the same way, one spring hanger 108 is shown partially cut-away, so that the front eye wraps 130 may be more clearly illustrated as attached to the spring hanger connections 109. One spring shackle 110 is shown partially cut-away as well, so that the rear eye wraps 131 may be more clearly illustrated as attached to the spring shackle connections 112. As in the prior art suspensions, the spring hanger 108 is attached to the frame 103, and the spring shackle connection 112 is attached to the spring shackle 110, which spring shackle 110 is connected to the spring shackle attachment 111, which spring shackle attachment 111 is attached to the frame 103. The flat leaf spring front suspension 132 with the lower thick truncated half-leafs 133, the thin full leafs 129, and the upper thin truncated half-leafs 134, is provided with damper elements 114, which are also shown partially cut-away, and a stabilizer bar 115. As in the previous embodiments of the present invention, the flat leaf spring front suspension 132 of the present invention shown in FIG. 11 may be provided with or without the stabilizer bar 115. As in the prior art suspensions, the stabilizer bar 115 is attached to the solid front steerable axle 106 by means of the stabilizer bar axle connections 117, and is attached to the frame 103 by means of the stabilizer bar frame links 116. The damper elements 114 are connected to the frame 103 and to the solid front steerable axle 106 at or near the axle attachments 113.

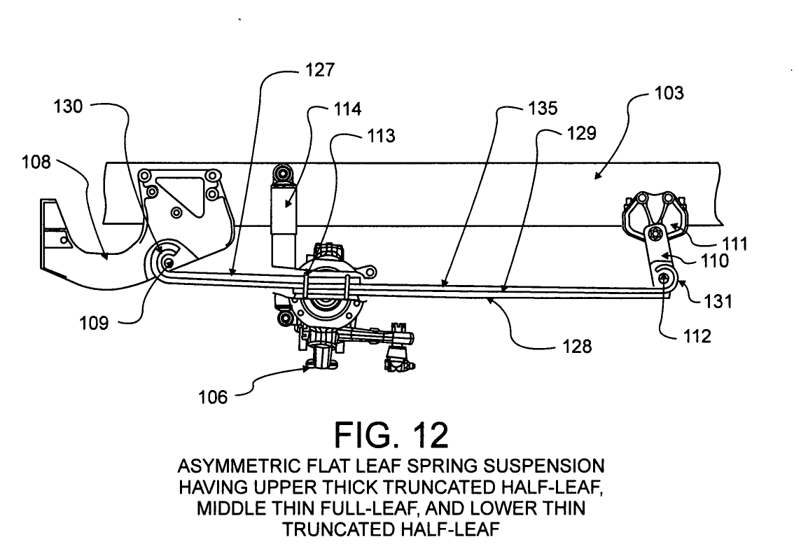

FIG. 12 shows an embodiment of the present invention, an asymmetric leaf spring front suspension 135 having upper thick truncated half-leafs 127, thin full leafs 129 with front eye wraps 130 and rear eye wraps 131, and lower thin truncated half-leafs 128. Note for clarity, the body 102 is not shown. The solid front steerable axle 106 is shown partially cut-away, such that the axle attachments 113 to the upper thick truncated half-leafs 127, the thin full leafs 129, and the lower thin truncated half-leafs 128 may be more clearly illustrated. In the same way, one spring hanger 108 is shown partially cut-away, so that the front eye wraps 130 may be more clearly illustrated as attached to the spring hanger connections 109. One spring shackle 110 is shown partially cut-away as well, so that the rear eye wraps 131 may be more clearly illustrated as attached to the spring shackle connections 112. Note that the solid front steerable axle 106 and axle attachments 113 are located proximate to the spring hangers 108 along the length of the thin full leafs 129, and distant from the spring shackles 110. The upper thick truncated half-leafs 127 are therefore shorter in length than in previous embodiments of the present invention, and the lower thin truncated half-leafs 128 are longer than in previous embodiments. As in the prior art suspensions, the spring hangers 108 are attached to the frame 103, and the spring shackle connections 112 are attached to the spring shackles 110, which spring shackles 110 are connected to the spring shackle attachments 111, which spring shackle attachments 111 are attached to the frame 103. The asymmetric leaf spring front suspension 135 is further provided with damper elements 114, which are also shown partially cut-away. The damper elements 114 are connected to the frame 103 and to the solid front steerable axle 106 at or near the axle attachments 113.

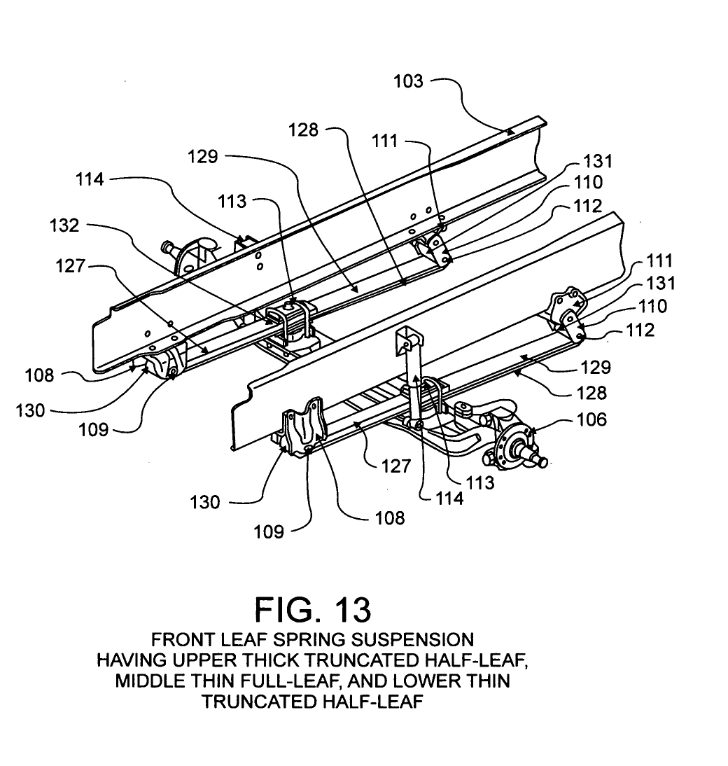

FIG. 13 shows an isometric view of an embodiment of the present invention, a flat leaf spring front suspension 132, similar to the flat leaf spring front suspension 132 shown in FIG. 10. The flat leaf spring front suspension 132 shown in FIG. 13 again is provided with upper thick truncated half-leafs 127, thin full leafs 129 with front eye wraps 130 and rear eye wraps 131, and lower thin truncated half-leafs 128. The front eye wraps 130 engage the spring hanger connections 109, which are attached to the spring hangers 108, which are in turn attached to the frame 103. The rear eye wraps 131 engage the spring shackle connections 112, which are attached to the spring shackles 110, which are in turn connected to the spring shackle attachments 111. The spring shackle attachments 111 are again attached to the frame 103. The solid front steerable axle 106 is attached to the upper thick truncated half-leafs 127, the thin full leafs 129, and the lower thin truncated half-leafs 128 by the axle attachments 113. The flat leaf spring front suspension 132 shown in FIG. 13 is again provided with damper elements 114, which damper elements 114 are connected to the frame 103 and to the solid front steerable axle 106 at or near the axle attachments 113.

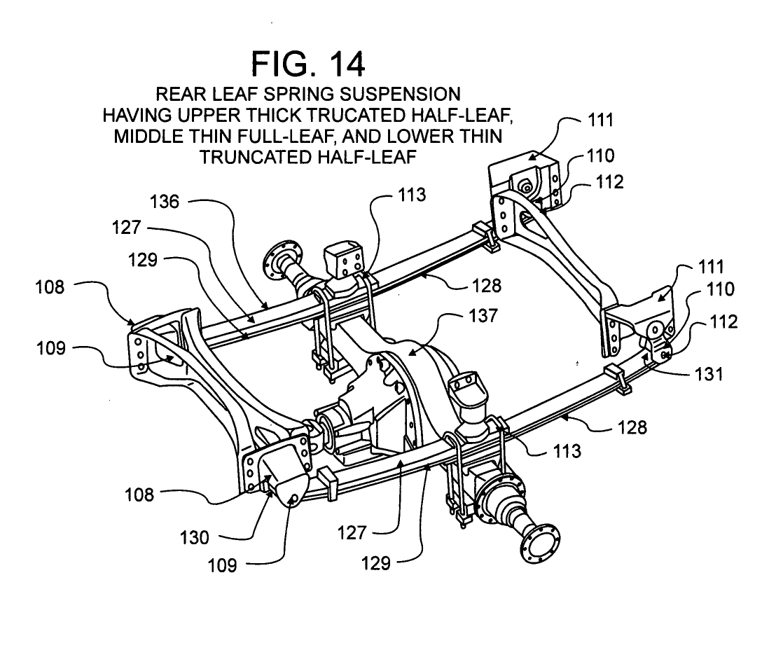

FIG. 14 shows an isometric view of an embodiment of the present invention, a leaf spring rear suspension 136 having upper thick truncated half-leafs 127, thin full leafs 129 with front eye wraps 130 and rear eye wraps 131, and lower thin truncated half-leafs 128. Of the front eye wraps 130 and rear eye wraps 131, note that only the left side eye wraps are visible in FIG. 14. Note also for clarity, neither the body 102, the frame 103, nor the damper elements 114 are shown. The solid rear driving axle 137 is attached to the upper thick truncated half-leafs 127, the thin full leafs 129, and the lower thin truncated half-leafs 128 by the axle attachments 113. The front eye wraps 130 engage the spring hanger connections 109, which spring hanger connections 109 are attached to the spring hangers 108, which spring hangers 108 are in turn attached to the frame 103, which frame 103 is not shown in FIG. 14. The rear eye wraps 131 engage the spring shackle connections 112, which spring shackle connections 112 are attached to the spring shackles 110, which spring shackles 110 are in turn connected to the spring shackle attachments 111. The spring shackle attachments 111 are again attached to the frame 103, which frame 103 is not shown in FIG. 14.

Other permutations of the invention are possible without departing from the teachings disclosed herein, provided that the function of the invention is to provide an increased auxiliary roll stiffness in a vehicle suspension via the use of thick truncated half-leafs, while alleviating a corresponding increase in leaf stress via the use of opposing thinner truncated half leafs. Other advantages to a vehicle suspension equipped with opposed thick and thin truncated half leafs may also be inherent in the invention, without having been described above.

I claim:

1. A vehicle for operation on the ground, said vehicle having a frame and at least one suspension system, said at least one suspension system comprising:
a left spring hanger and a right spring hanger, said left spring hanger and said right spring hanger being attached to said frame;
a left spring shackle attachment and a right spring shackle attachment, said left spring shackle attachment and said right spring shackle attachment being attached to said frame;
a left spring shackle pivotally connected to said left spring shackle attachment;
a right spring shackle pivotally connected to said right spring shackle attachment;
a solid axle;
a left spring assembly having a first end, a point of attachment along its length, and a second end, said left spring assembly being pivotally attached to said left spring hanger at said first end of said left spring assembly, said left spring assembly being attached to said solid axle at said point of attachment, and said left spring assembly being pivotally attached to said left spring shackle at said second end of said left spring assembly, said left spring assembly further having a thick truncated half-leaf, a thin full-leaf, and a thin truncated half-leaf, said thin full-leaf being arranged between said thick truncated half-leaf and said thin truncated half-leaf, said thick truncated half-leaf extending between said first end and said point of attachment of said left spring assembly, said thin full-leaf extending between said first end and said second end of said left spring assembly, and said thin truncated half-leaf extending between said point of attachment and said second end of said left spring assembly; and
a right spring assembly having a first end, a point of attachment along its length, and a second end, said right spring assembly being pivotally attached to said right spring hanger at said first end of said right spring assembly, said right spring assembly being attached to said solid axle at said point of attachment, and said right spring assembly being pivotally attached to said right spring shackle at said second end of said right spring assembly, said right spring assembly further having a thick truncated half-leaf, a thin full-leaf, and a thin truncated half-leaf, said thin full-leaf being arranged between said thick truncated half-leaf and said thin truncated half-leaf, said thick truncated half-leaf extending between said first end and said point of attachment of said right spring assembly, said thin full-leaf extending between said first end and said second end of said right spring assembly, and said thin truncated half-leaf extending between said point of attachment and said second end of said right spring assembly.

2. The vehicle for operation on the ground of claim 1, wherein:
said thin full-leaf of said left spring assembly and said thin full-leaf of said right spring assembly both being provided with at least one eye wrap at said first ends.

3. The vehicle for operation on the ground of claim 1, wherein:
said left spring assembly and said right spring assembly each describe a parabolic arc when in an uncompressed state.

4. The vehicle for operation on the ground of claim 1, wherein:
said left spring assembly and said right spring assembly are approximately planar when in an uncompressed state.

5. The vehicle for operation on the ground of claim 1, wherein:
said thick truncated half-leaf of said left spring assembly being located above said thin full-leaf of said left spring assembly, and said thin truncated half-leaf of said left spring assembly being located below said thin full-leaf of said left spring assembly; and
said thick truncated half-leaf of said right spring assembly being located above said thin full-leaf of said right spring assembly, and said thin truncated half-leaf of said right spring assembly being located below said thin full-leaf of said right spring assembly.

6. The vehicle for operation on the ground of claim 1, wherein:
said thick truncated half-leaf of said left spring assembly being located below said thin full-leaf of said left spring assembly, and said thin truncated half-leaf of said left spring assembly being located above said thin full-leaf of said left spring assembly; and
said thick truncated half-leaf of said right spring assembly being located below said thin full-leaf of said right spring assembly, and said thin truncated half-leaf of said right spring assembly being located above said thin full-leaf of said right spring assembly.

7. The vehicle for operation on the ground of claim 1, wherein:
said point of attachment of said left spring assembly being located at a point near the midpoint between said first end and said second end of said left spring assembly; and
said point of attachment of said right spring assembly being located at a point near the midpoint between said first end and said second end of said right spring assembly.

8. The vehicle for operation on the ground of claim 1, wherein:
said point of attachment of said left spring assembly being located at a point nearer to said first end and more distant from said second end of said left spring assembly; and
said point of attachment of said right spring assembly being located at a point nearer to said first end and more distant from said second end of said right spring assembly.

9. The vehicle for operation on the ground of claim 1, wherein:
said solid axle further comprises a solid front steerable axle.

10. The vehicle for operation on the ground of claim 1, wherein:
said solid axle further comprises a solid rear drivable axle.

11. A vehicle for operation on the ground, said vehicle having a frame and at least one suspension system, said at least one suspension system comprising:
a left forward spring attachment and a right forward spring attachment, said left forward spring attachment and said right forward spring attachment being attached to said frame;
a left rearward spring attachment and a right rearward spring attachment, said left rearward spring attachment and said right rearward spring attachment being attached to said frame;
a solid axle;
a left spring assembly having a first end, a point of attachment along its length, and a second end, said left spring assembly being pivotally attached to said left forward spring attachment at said first end of said left spring assembly, said left spring assembly being attached to said solid axle at said point of attachment, and said left spring assembly being pivotally and longitudinally-translationally coupled to said left rearward spring attachment at said second end of said left spring assembly, said left spring assembly further having a thick truncated half-leaf, a thin full-leaf, and a thin truncated half-leaf, said thin full-leaf being arranged between said thick truncated half-leaf and said thin truncated half-leaf, said thick truncated half-leaf extending between said first end and said point of attachment of said left spring assembly, said thin full-leaf extending between said first end and said second end of said left spring assembly, and said thin truncated half-leaf extending between said point of attachment and said second end of said left spring assembly; and
a right spring assembly having a first end, a point of attachment along its length, and a second end, said right spring assembly being pivotally attached to said right forward spring attachment at said first end of said right spring assembly, said right spring assembly being attached to said solid axle at said point of attachment, and said right spring assembly being pivotally and longitudinally-translationally coupled to said right rearward spring attachment at said second end of said right spring assembly, said right spring assembly further having a thick truncated half-leaf, a thin full-leaf, and a thin truncated half-leaf, said thin full-leaf being arranged between said thick truncated half-leaf and said thin truncated half-leaf, said thick truncated half-leaf extending between said first end and said point of attachment of said right spring assembly, said thin full-leaf extending between said first end and said second end of said right spring assembly, and said thin truncated half-leaf extending between said point of attachment and said second end of said right spring assembly.

12. The vehicle for operation on the ground of claim 11, wherein:
said thin full-leaf of said left spring assembly and said thin full-leaf of said right spring assembly both being provided with at least one eye wrap at said first ends.

13. The vehicle for operation on the ground of claim 11, wherein:
said left spring assembly and said right spring assembly each describe a parabolic arc when in an uncompressed state.

14. The vehicle for operation on the ground of claim 11, wherein:
said left spring assembly and said right spring assembly are approximately planar when in an uncompressed state.

15. The vehicle for operation on the ground of claim 11, wherein:
said thick truncated half-leaf of said left spring assembly being located above said thin full-leaf of said left spring assembly, and said thin truncated half-leaf of said left spring assembly being located below said thin full-leaf of said left spring assembly; and
said thick truncated half-leaf of said right spring assembly being located above said thin full-leaf of said right spring assembly, and said thin truncated half-leaf of said right spring assembly being located below said thin full-leaf of said right spring assembly.

16. The vehicle for operation on the ground of claim 11, wherein:
said thick truncated half-leaf of said left spring assembly being located below said thin full-leaf of said left spring assembly, and said thin truncated half-leaf of said left spring assembly being located above said thin full-leaf of said left spring assembly; and
said thick truncated half-leaf of said right spring assembly being located below said thin full-leaf of said right spring assembly, and said thin truncated half-leaf of said right spring assembly being located above said thin full-leaf of said right spring assembly.

17. The vehicle for operation on the ground of claim 11, wherein:
said point of attachment of said left spring assembly being located at a point near the midpoint between said first end and said second end of said left spring assembly; and
said point of attachment of said right spring assembly being located at a point near the midpoint between said first end and said second end of said right spring assembly.

18. The vehicle for operation on the ground of claim 11, wherein:
said point of attachment of said left spring assembly being located at a point nearer to said first end and more distant from said second end of said left spring assembly; and
said point of attachment of said right spring assembly being located at a point nearer to said first end and more distant from said second end of said right spring assembly.

19. The vehicle for operation on the ground of claim 11, wherein:
said solid axle further comprises a solid front steerable axle.

20. The vehicle for operation on the ground of claim 11, wherein:
said solid axle further comprises a solid rear drivable axle.
